(19) United States
(12) Patent Application Publication
(10) Pub. No.: US 2006/0147579 A1
(43) Pub. Date: Jul. 6, 2006

(54) Fish feed compositions

(75) Inventor: Kristin Hamre, Bergen (NO)

Correspondence Address: BACON & THOMAS, PLLC, 625 SLATERS LANE, FOURTH FLOOR, ALEXANDRIA, VA, 22314, US

(73) Assignee: FORINNOVA AS, BERGEN (NO)

(21) Appl. No.: 10/541,889

(22) PCT Filed: Jan. 12, 2004
(86) PCT No.: PCT/GB04/00084

§ 371 Date: Feb. 21, 2006

(30) Foreign Application Priority Data
Jan. 10, 2003 (GB) 0300602.0

(51) Int. Cl. A23K 1/18

(52) U.S. Cl. 426/2

(57) ABSTRACT

The present invention provides a fish feed comprising a live feed component which has been fed with an acylglycerol composition which comprises mono and/or diacylglycerols of at least one fatty acid selected from eicosapentaeneoic acid and docosahexaeneoic acid.

This invention relates to a composition for use in feeding fish, in particular pre-adult stage fish, especially marine fish larvae and particularly larvae of flatfish, e.g. halibut fry.

Marine fish larvae in aquaculture are normally fed with live feed, in particular rotifers (Bachionus plicatills) and Artemia (brine shrimp), during the first 4 to 6 weeks of exogenous feeding.

Artemia for use in aquaculture may be obtained commercially in the dormant egg or cyst form (e.g. from Wudi County Haotian Artemia Cysts Co., Ltd of Wudi County, Shandong, China). These may be hatched in aqueous saline (e.g. filtered sea water) and within 18 to 48 hours produce the live baby shrimp or nauplius form which is used as fish feed. The Artemia comprise about 48% protein and 18% lipid and thus are generally considered to be an excellent nutrient for fish, including shellfish, in aquaculture.

Nonetheless, fish larvae fed on rotifers and Artemia have a tendency towards developmental errors in pigmentation and metamorphosis, e.g. incomplete eye migration in flatfish. To some extent this problem has been addressed by enriching rotifer/Artemia feeds with marine fish oils (e.g. cod liver oil) prior to distributing the feed to the larvae.

The marine fish oils used in this regard are generally triacylglycerols, i.e. triglycerides, and contain a proportion of C₂₀ and C₂₂ omega-3 fatty acid (i.e. eicosapentaeneoic acid (EPA—C20:5n-3) and decosahexaeneoic acid (DHA—C22:6n-3)) residues.

We have now surprisingly found that developmental errors in fish larvae growth can be reduced and survival, growth and feed utilization can be improved by supplementing the live feed with an acylglycerol composition which contains mono and/or diacylglycerols having C₂₀ and/or C₂₂ omega-3 fatty acid residues.

This supplementation may be achieved by allowing the live feed to consume the acylglycerol composition. In effect therefore the live feed then serves in part as a food source for the fish larvae and in part as a carrier for delivering the acylglycerol composition. Simply administering the acylglycerol composition to the fish larvae, e.g. as an emulsion, would result in little if any being consumed by the fish larvae.

Thus viewed from one aspect the invention provides a fish feed comprising a live feed component which has been fed with an acylglycerol composition which comprises mono and/or diacylglycerols of at least one fatty acid selected from eicosapentaeneoic acid and docosahexaeneoic acid, e.g. as at least 5% wt of the total acylglycerol content, especially at least 110% wt, more preferably at least 30% wt, particularly at least 45% wt, for example up to 100% wt.

Viewed from a further aspect the invention also provides a process for the preparation of fish feed, said process comprising contacting an acylglycerol composition and a live feed component, characterized in that said acylglycerol composition comprises mono and/or diacylglycerols of at least one fatty acid selected from eicosapentaeneoic acid and docosahexaeneoic acid, e.g. as at least 10% wt of the total acylglycerol content, especially at least 20% wt, more preferably at least 30% wt, particularly at least 45% wt, for example up to 100% wt.

The acylglycerol fed to the live feed component may be a monoacylglycerol, a diacylglycerol, a mixture of mono- and diacylglycerols, a mixture of mono- and triacylglycerols, a mixture of di- and triacylglycerols or a mixture of mono-, di- and triacylglycerols. Preferably it comprises at least mono and diacylglycerols containing EPA and/or DHA residues, e.g. containing at least 30% wt, more preferably at least 40% wt, especially at least 50% wt, more especially at least 55% wt of EPA and/or DHA based on the total fatty acid content. Especially preferably at least 25% wt of the EPA, DHA or EPA and DHA residues are present in mono- or diacylglycerols, more especially at least 50% wt. In an especially preferred aspect, the acylglycerol composition also contains acylglycerols having arachidonic acid (AA) residues, preferably in mono and/or diacylglycerols.

Where the EPA or DHA is present in a monoacylglycerol, no other fatty acid residue will be present in the compound. Where however they are present in di- or triacylglycerols, one or two further fatty acid residues will be present. These will preferably be C₁₆₋₂₄ omega-3 or omega-6 acids, especially EPA, DHA or arachidonic acid, i.e. the acylglycerol composition preferably contains diacylglycerol compounds having two EPA or DHA residues, one DHA and one EPA residue, one EPA and one AA residue, or one DHA and one AA residue. Diacylglycerol containing two AA residues and/or monoacylglycerol containing one AA residue may also conveniently be present in the composition. Where the composition also contains triacylglycerols, at least some of these will preferably contain EPA, DHA and/or AA residues.

The DHA content of the acylglycerol composition (relative to total fatty acid content) is preferably at least 10% wt, more preferably at least 20% wt, particularly at least 30% wt, especially at least 45% wt, e.g. up to 100% wt. The EPA content (where EPA is present) is preferably at least 10% wt, more preferably at least 15% wt, e.g. up to 50% wt.

Acylglycerols containing omega-3 acids of marine origin are available commercially, e.g. as EPAX oils from Pronova Biocare of Norway (see www.pronova.com). Examples of available EPAX oils include EPAX 2050 TG (which has an eicosapentaeneoic acid (EPA) content of about 20% wt and a decosahexaeneoic acid (DHA) content of about 50% wt and a high mono and diacylglycerol content), EPAX 0626 TG (which has an EPA content of about 6% wt and a DHA content of about 25% wt), EPAX 3000 TG (which has an EPA content of 16-20% wt and a DHA content of 11-13% wt), EPAX 5000 TG (which has an EPA content of about 30% wt and a DHA content of about 20% wt).

Acylglycerols containing omega-6 acids are also widely available commercially.

Mono and diacylglycerols for use according to the invention may be prepared by hydrolysis of omega-3 and/or omega-6 acid containing di and triacylglycerols or by esterification of glycerol or monoacylglycerols with appropriate omega-3 and/or omega-6 fatty acids.

Mono- and diacylglycerols containing only DHA, EPA and/or AA residues are themselves novel and form a further aspect of the invention, e.g. in a form substantially free of other acylglycerols, for example at least 90% wt pure, preferably at least 95% wt pure. These can readily be prepared by esterification of glycerol with optionally activated forms of these acids.

In the fish feeds of the invention, the live feed component may be any live aquatic animal organism of a size able to be consumed by larval fish, e.g. a monocellular species or a multicellular species having a maximum dimension of up to about 2 mm. Preferably the live feed component comprises zooplankton, Claderocera (e.g. Daphnidae, such as D. rosea), rotifers (Brachionus plicatilis) or Artemia, especially Artemia, and in particular Arternia nauplii. Artemia and other such live feed organisms are available commercially, e.g. in the case of Artemia in the dormant cyst form as discussed above. The live feed components will preferably be administered in water, e.g. saline, for example with a salinity (or otherwise expressed osmolality) of from 30 to 120% that of seawater (i.e. 300 to 1200 mOSm/kg).

The live feed compositions according to the invention may conveniently be prepared by addition of an oil-in-water emulsion of the acylglycerols to water containing live feed or by addition of live feed for live feed to an oil-in-water emulsion. The emulsions can be produced by conventional emulsification processes, e.g. by sonification, by using a rotor-stator mixer or by extrusion through a membrane with appropriate pore sizes. Typically droplet sizes from 1 to 100 μm, especially 5 to 50 μm may be used. To assist in emulsion formation, physiologically tolerable emulsification aids, e.g. surfactants such as Tweens, may be added. The aqueous phase of the emulsion will preferably be saline, e.g. as mentioned above.

The acylglycerol will normally be fed to the live feed component at a concentration of about 0.01 to 0.20 g/L, especially 0.05 to 0.10 g/L.

The live feed component will preferably be allowed to consume most or all of the acylglycerol droplets before being fed to the fish or fish larvae. Generally the droplets will be consumed in about 12 to 48 hours, especially about 24 hours, and the live feed component should then be fed to the fish or fish larvae within about 48 hours, preferably within 24 hours, more preferably within 1 hour. If the period between droplet consumption and use as feed is to be prolonged (e.g. over 1 hour), the live feed component is preferably stored under cooling, e.g. at 7 to 8° C. The live feed component will generally be filtered and washed before being fed to the fish or fish larvae.

Besides live feed containing feed compositions, fish at larval and post larval stages may also be fed with formulated feeds containing a mono and/or diacylglycerol composition in accordance with the definitions of the acylglycerol composition given above, e.g. feeds containing further components selected from proteins, lipids, carbohydrates, colors, vitamins, and minerals.

Thus viewed from a further aspect the invention provides the use in the preparation of a fish feed, e.g. a formulated fish feed, of mono and/or diacylglycerols containing EPA and/or DHA residues.

Viewed from a yet still further aspect the invention provides a method of raising fish comprising feeding fish or fish larvae with an acylglycerol-containing feed, characterized in that said adylglycerol comprises mono, and/or diacylglycerols containing EPA and/or DHA residues.

The acylglycerols and/or other lipids may be incorporated into a fish feed in conventional fashion, e.g. by addition to a powdered mixture of other feed components such as for example fish meal, animal and/or vegetable protein, single cell organism protein, cereal flour, gluten, etc, followed by pelletization and drying. Alternatively the acylglycerols and/or other lipids may be combined with minced or emulsified fish, optionally containing other feed components such as animal and/or vegetable protein, single cell organism protein, cereal flour, gluten, etc, extruded, and heated (e.g. with microwave irradiation). The final feed product will typically be in pellet, granule, powder or flake form, preferably granule or powder form, e.g. with a particle size of 50 to 1500 μm, preferably 100 to 1000 μm.

Any variety of fish or fish larvae may be fed according to the invention, including both marine and freshwater fish as well as shellfish and crustaceans, e.g. cod, hake, haddock, halibut, dab, flounder, Japanese flounder, whiting, sole, turbot, sea bass, sea bream, tuna, prawn, shrimp, crab, lobster, crayfish, langoustine, oyster, mussel, scallop, whelk, cockle, etc. The invention however is especially applicable to prawn, shrimp and vertebrate marine fish and particularly flatfish, i.e. fish which undergo a transformation involving eye migration during their larval stage. The invention is particularly suitable for larval halibut.

In the case of filter feeding fish, e.g. shellfish such as bivalves, the acylglycerols may be administered as an emulsion, optionally containing lipid-soluble additives dispersed in the discontinuous oil phase. Thus viewed from a further aspect the invention provides a method of raising fish comprising feeding filter-feeding fish with an acylglycerol containing feed, characterized in that said feed comprises an oil-in-water emulsion containing mono and/or diacylglycerols of at least one fatty acid selected from EPA and DHA. In such emulsions, the acylglycerol phase is preferably an acylglycerol or acylglycerol composition as described above and the droplet size is preferably 1 to 100 μm, especially 5 to 50 μm.

The invention, i.e. the inclusion in feed of mono- and/or diacylglycerols containing EPA and/or DHA residues is also applicable to feeds for air breathing juvenile vertebrates, e.g. mammals such as sheep, cows, pigs, dogs, cats, humans, etc and birds such as chickens, ducks, geese, turkeys, grouse, pheasants, etc. In particular it is suitable for use with such juveniles suffering from poor digestive ability. Feed according to the invention for such juveniles will preferably contain the mono- and/or diacylglycerols in the same proportions as described herein for fish feeds, preferably together with at least one further nutrient selected from carbohydrates, lipids, proteins, protein hydrolysates, vitamins and minerals and mixtures thereof, e.g. milk, fruit, vegetable, meat, fish, cereal, etc.

In one particularly preferred embodiment, the mono and/or diacylglycerols will be incorporated into milk powder (e.g. by spray drying milk enriched with the mono and/or diacylglycerols) or into pureed cooked fruit, vegetable or meat. The quantity of mono and/or diacylglycerols used will typically be 1 to 30% wt, more preferably 2 to 15% wt of the compositions dry weight. Advantageously, such compositions will also contain mono and/or diacylglycerols of C₁₆₋₂₄ omega-6 fatty acids, especially C₁₈₋₂₂ omega-6 fatty acids. Such feed compositions form further aspects of the invention.

The invention will now be illustrated by the following non-limiting Example.

### EXAMPLE 1

An aqueous emulsion was prepared containing 60% wt. EPAX 2050 TG (available from Pronova Biocare, Norway), 5% wt Tween 20 and 25% wt seawater (33 ppt salt).

An equivalent emulsion was prepared using cod liver oil (from Peter Miller AS, Oslo, Norway) in place of the EPAX 2050 TG.

Artemia cysts were decapsulated and hatched using conventional techniques and at the N*2 nauplius stage were transferred to enrichment tanks. The emulsions were added to bring the acylglycerol content in the tanks to 0.08 g/L and the tanks were left for 24 hours to allow the artemia to consume the acylglycerols. The acylglycerol enriched Artemia were then fed to halibut larvae in triplicate tanks for a period of 77 days. This enriched Artemia feed was given to the larvae immediately following the yolk sac stage, i.e. as the first exogenous feed. At 1, 13, 46 and 77 days, larvae were removed and their fatty acid content was measured. At 77 days the mean weight, percentage survival and percentage eye migration was determined for each group.

The results were as follows:

| | | Cod liver |
|---|---|---|
| Acylglycerol | EPAX 2050TG | oil |
| Survival (%) | 38 | 11 |
| Final wet weight (g) | 0.24 | 0.18 |
| Average eye migration (%) | 48 | 23 |
| Fatty acid content | | |
| (mg/g wet weight) | | |
| Day 1 | 7 | 7 |
| Day 13 | 7 | 3 |
| Day 46 | 41 | 12 |
| Day 77 | 27 | 13 |
| DHA* | 8.8 | 4.4 |
| EPA* | 11.1 | 10.4 |
| AA* | 3.8 | 3.7 |

*as a percentage of total fatty acid content at 77 days

1. A fish feed comprising a live feed component which has been fed with an acylglycerol composition which comprises mono and/or diacylglycerols of at least one fatty acid selected from eicosapentaeneoic acid and docosahexaeneoic acid.

2. A fish feed as claimed in claim 1 wherein the content of said mono and/or diacylglycerols is at least 45% wt of the total acylglycerol content.

3. A fish feed as claimed in claim 1 wherein said fish are flatfish larvae.

4. A process for the preparation of fish feed, said process comprising contacting an acylglycerol composition and a live feed component characterised in that said acylglycerol composition comprises mono and/or diacylglycerols of at least one fatty acid selected from eicosapentaeneoic acid and docosahexaeneoic acid.

5. A process as claimed in claim 4 wherein the content of said mono and/or diacylglycerols is at least 45% wt of the total acylglyercol content.

6. A process as claimed in claim 4 wherein said acylglycerol composition comprises at least mono and diacylglycerols containing EPA and/or DHA residues.

7. A process as claimed in claim 4 wherein said acylglycerol composition contains acylglycerols having arachidonic acid (AA) residues.

8. A process as claimed in claim 4 wherein said acylglycerol is fed to said live feed component at a concentration of about 0.05 to 0.10 g/l.

9. (canceled)

10. A method of raising fish comprising feeding fish or fish larvae with an acylglycerol-contaiing feed, characterized in that said acylglycerol comprises mono and/or diacylglycerols containing EPA and/or DHA residues.

11. A method of raising fish comprising feeding filter-feeding fish with an acylglycerol containing feed, characterized in that said feed comprises an oil-in-water emulsion containing mono and/or diacylglycerols of at least one fatty acid selected from EPA and DHA.

12. An aquatic animal organism having a maximum dimension of 2 mm and having in its digestive tracts mono and/or diacylglycerols containing EPA and/or DHA residues.

13. Milk powder containing mono and/or diacylglycerols containing EPA and/or DHA residues.

14. Puréed cooked fruit, meat or vegetable containing mono and/or diacylglycerols containing EPA and/or DHA residues.

15. A diacylglycerol wherein both fatty acid groups are EPA, DHA and/or AA residues.
